(19) United States
(12) Patent Application Publication
(10) Pub. No.: US 2014/0175238 A1
(43) Pub. Date: Jun. 26, 2014

(54) System and Method for Installing Aftertreatment Bricks

(71) Applicant: CATERPILLAR INC., Peoria, IL (US)

(72) Inventors: Stephan D. Roozenboom, Washington, IL (US); Mirza P. Baig, Peoria, IL (US); Raymond B. Gerges, Peoria, IL (US); Tetsu O. Velasquez, Washington, IL (US); Kevin Weiss, Peoria, IL (US); Raymond U. Isada, Peoria, IL (US)

(73) Assignee: Caterpillar Inc., Peoria, IL (US)

(21) Appl. No.: 13/727,182

(22) Filed: Dec. 26, 2012

(51) Int. Cl. F16B 2/08

(52) U.S. Cl. CPC F16B 2/08
USPC 248/201

(57) ABSTRACT

An aftertreatment brick can be installed in a brick compartment of an aftertreatment module with a releasable securing assembly. The releasable securing assembly includes a first bracket, a second bracket, and a band clamp. The first bracket is installed in the brick compartment proximate a port. The aftertreatment brick is placed on the first bracket adjacent the port and the second bracket is placed about the aftertreatment brick above the first bracket. The band clamp is slid over the first and second brackets and tightened to secure the brackets about the brick.

### TECHNICAL FIELD

This patent disclosure relates generally to a system and method for accommodating an aftertreatment brick in an aftertreatment system and, more particularly, to a system and method for releasably securing the aftertreatment brick inside the system.

### BACKGROUND

Industrial scale power systems may include large internal combustion engines or similar devices that burn hydro-carbon based fuels or similar fuel sources to convert the chemical energy therein to mechanical energy that can be utilized to power an associated machine or application. The combustion of such fuel sources may create or release byproducts and emissions like hydrocarbons (H—C); carbon dioxide and carbon mono-oxide; nitrogen oxides (NO and NO₂, commonly referred to a NO_{X}) and particulate matter. The quantity or characteristics of these byproducts and emissions that can be discharged to the environment may be subject to governmental regulation. Accordingly, to treat the byproducts and emissions for compliance with possible regulations, the power systems may be associated with exhaust gas aftertreatment systems.

The aftertreatment system may be disposed in the exhaust channel of the power system and may include a unit or module through which the exhaust gasses may be directed. The aftertreatment module may utilize one or more aftertreatment devices that can remove or convert the byproducts and/or emissions in the exhaust gasses. Specifically, these devices may include aftertreatment bricks made of materials or substances that change, chemically or physically, the composition of the exhaust gasses that encounter the bricks. Examples of aftertreatment bricks include catalysts that chemically alter the exhausts and filters that can trap specific components of the exhaust gasses. Because some types of aftertreatment bricks may become depleted or deactivated over time, or may become damaged due to the conditions in which they operate, the aftertreatment bricks may be removable from the aftertreatment module.

An example of an aftertreatment system configured for removable catalysts is described in U.S. Pat. No. 5,169,604 (the '604 patent). The '604 patent describes a generally tubular housing assembly that establishes a flow path into which one or more catalyst carriers can be placed. To access the catalyst carriers inside the housing assembly, a removable cover covers a hatch disposed in the assembly. To lift the catalyst carriers through the hatch, a U-shaped removal means extends partially around the catalyst carriers. Hence, the catalyst carriers can be set inside and removed from the housing. The present disclosure is directed to enabling similar functionality in an aftertreatment system.

### SUMMARY

In an aspect, the disclosure describes a method of releasably securing an aftertreatment brick in an aftertreatment system. According to the method, a first bracket is installed in a brick compartment disposed along the exhaust flow path of the aftertreatment system. The first bracket may have a first surface complementary to a periphery of the aftertreatment brick. The aftertreatment brick is placed on the first bracket so that the first surface is adjacent a portion of the periphery of the brick. A second bracket is installed in the brick compartment and may include a second surface complementary to the periphery of the aftertreatment brick. The second bracket is installed so that the second surface is adjacent another portion of the periphery of the aftertreatment brick. A band clamp is secured about the first and second brackets to secure the first and second brackets to the aftertreatment brick.

In another aspect, the disclosure provides a releasable securing assembly for securing an aftertreatment brick inside an aftertreatment system. The assembly includes a first bracket having a first surface complementary to a periphery of the aftertreatment brick. The first bracket is adapted to be permanently installed in a brick compartment of the aftertreatment system. The assembly also includes a second bracket having a second surface also complementary to the periphery of the aftertreatment brick and which is adapted to be removably installed in the brick compartment. The assembly further includes a band clamp adapted to be secured about the first bracket and the second bracket to compress the first bracket and the second bracket about the aftertreatment brick.

In yet a further aspect, the disclosure provides another method for servicing an aftertreatment brick in an aftertreatment system. According to the method, a brick compartment is accessed through an access hatch to access the aftertreatment bricks. A band clamp is slid off a first bracket and a second bracket securing an aftertreatment brick in the brick compartment. The second bracket, proximate the hatch, is uninstalled and removed from the brick compartment. The aftertreatment brick may then be lifted from the first bracket and removed from the brick compartment.

### BRIEF DESCRIPTION OF THE DRAWING(S)

FIG. 1 is a side elevational view of a power system including an internal combustion engine coupled to a generator and associated with a clean emissions module.

FIG. 2 is a perspective view of the clean emissions module with the top removed to illustrate the components inside of, and exhaust flow through, the module.

FIG. 3 is a perspective view of an embodiment of an aftertreatment brick having one or more protruding ribs around its periphery.

FIG. 4 is a perspective view of the aftertreatment brick releasably secured between a first bracket and a second bracket inside a brick compartment of the clean emissions module.

FIG. 5 is a perspective view of a step of installing the aftertreatment brick illustrating the brick compartment with a lower bracket for supporting the aftertreatment brick attached proximate to a port accessing the compartment.

FIG. 6 is a perspective view of another installation step illustrating one or more aftertreatment bricks inserted into the brick compartment, each brick including a band clamp disposed loosely thereabout.

FIG. 7 is a perspective view of another installation step illustrating an upper bracket being installed proximate the port accessing the brick compartment.

FIG. 8 is a perspective view of another installation step showing the band clamp secured about the upper and lower brackets around the aftertreatment brick.

FIG. 9 is a cross-sectional view taken along lines 9-9 of FIG. 8 showing the axial engagement between the protruding ribs on the aftertreatment brick and the steps on the first and/or second brackets.

### DETAILED DESCRIPTION

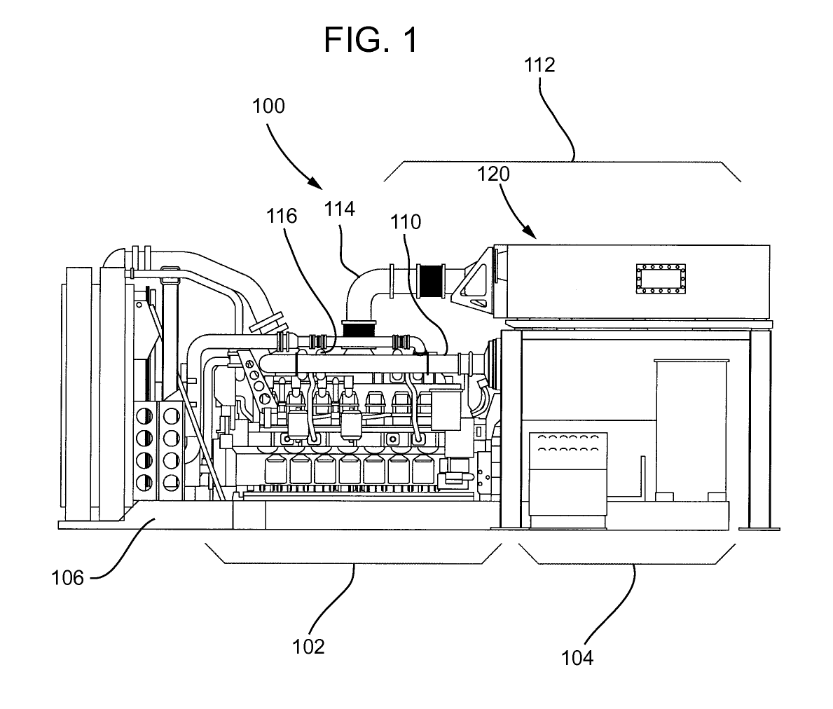

This disclosure relates generally to an exhaust aftertreatment system that may be associated with a power system producing exhaust gasses and, more particularly, relates to aftertreatment bricks that may be a removable component of such aftertreatment systems. Now referring to the drawings, wherein like reference numbers refer to like elements, there is illustrated in FIG. 1 an example of a power system 100 for use in an industrial setting that can generate power by combusting fossil fuels or the like. The illustrated power system 100 can include an internal combustion engine 102 such as a diesel engine operatively coupled to a generator 104 for producing electricity. The internal combustion engine 102 may have any number of cylinders as may be appreciated by one of ordinary skill in the art. The internal combustion engine 102 and the generator 104 can be supported on a common mounting frame 106. The power system 100 can provide on-site stand-by power or continuous electrical power at locations where access to an electrical grid is limited or unavailable. Accordingly, the generator 104 and internal combustion engine 102 can be scaled or sized to provide suitable wattage and horsepower. It should be appreciated that in other embodiments, the power system of the present disclosure can be utilized with power sources such as gasoline burning engines, natural gas turbines, and coal burning systems. Further, in addition to stationary or industrial applications, the present disclosure can be utilized in mobile applications such as locomotives and marine engines.

To direct intake air into and exhaust gasses from the power system 100, the power system can include an air introduction system 110 and an exhaust system 112. The air introduction system 110 introduces air or an air/fuel mixture to the combustion chambers of the internal combustion engine 102 for combustion while the exhaust system 112 includes an exhaust pipe or exhaust channel 114 in fluid communication with the combustion chambers to direct the exhaust gasses produced by the combustion process to the environment. To pressurize intake air by utilizing the positive pressure of the expelled exhaust gasses, the power system 100 can include one or more turbochargers 116 operatively associated with the air introduction system 110 and the exhaust system 112.

The exhaust system 112 can include components to condition or treat the exhaust gasses before they are discharged to the environment. For example, an exhaust aftertreatment system 120 in the form of a clean emissions module (CEM) can be disposed in fluid communication with the exhaust system 112 downstream of the turbochargers 116 to receive the exhaust gasses discharged from the internal combustion engine 102. The term “aftertreatment” refers to the fact that the system treats exhaust gasses after they have been produced and is therefore distinguishable from fuel additives and the like that affect the combustion process. The aftertreatment system 120 can be designed as a separate unit that can be mounted to the power system 100 generally over the generator 104, for example, and can receive exhaust gasses from the exhaust channel 114. By manufacturing the aftertreatment system 120 as a separate modular unit, the design can be utilized with different sizes and configurations of the power system 100. However, in other embodiments, the aftertreatment system 120 can be integral with the power system 100 and can be disposed at other locations rather than above the power system.

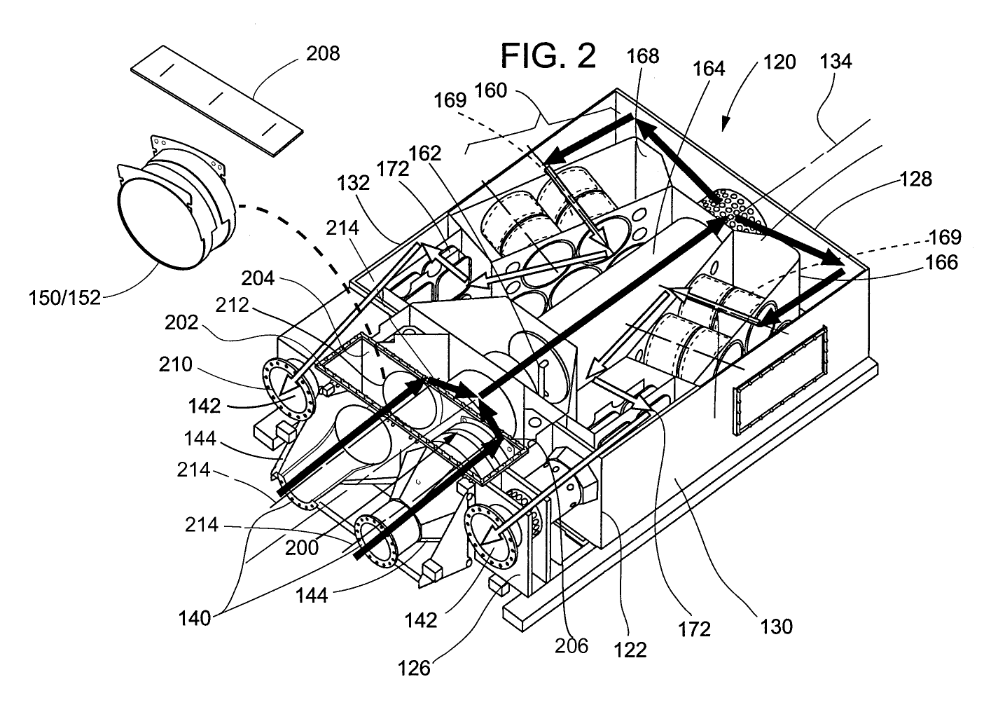

Referring to FIG. 2, the aftertreatment system 120 can include a box-like housing 122 that is supported on a base support 124 adapted to mount the aftertreatment system to the power system. The box-like housing 122 can include a forward-directed first wall 126, an opposing rearward second wall 128, and respective third and fourth sidewalls 130, 132. However, it should be appreciated that terms like forward, rearward and side are used only for orientation purposes and should not be construed as a limitation on the scope of the claims. Additionally, extending between the forward first wall 126 and rearward second wall 128 and located midway between the third and fourth sidewalls 130, 132 can be an imaginary central system axis line 134. The housing 122 may be made from welded steel plates or sheet material.

To receive the untreated exhaust gasses into the aftertreatment system 120, one or more inlets 140 can be disposed through the first wall 126 of the housing 122 and can be coupled in fluid communication to the exhaust channel from the exhaust system. In the embodiment illustrated, the aftertreatment system 120 includes two inlets 140 arranged generally in parallel and centrally located between the third and fourth sidewalls 130, 132 on either side of the system axis line 134 so that the entering exhaust gasses are directed toward the rearward second wall 128. However, other embodiments of the aftertreatment system 120 may include different numbers of and/or locations for the inlets. To enable the exhaust gasses to exit the aftertreatment system 120, two outlets 142 can also be disposed through the first wall 126 of the housing 122. Each outlet 142 can be parallel to the centrally disposed inlets 140 and can be aligned adjacent to one of the respective third and fourth sidewalls 130, 132.

To treat or condition the exhaust gasses, the housing 122 can contain various types or kinds of exhaust treatment devices through or past which the exhaust gasses are directed. For example and following the arrows indicating exhaust flow through the aftertreatment system 120, in order to slow the velocity of the incoming exhaust gasses for treatment, the inlets 140 can each be communicatively associated with an expanding, cone-shaped inlet diffuser 144 mounted exteriorly of the front first wall 126. Each inlet diffuser 144 can direct the exhaust gasses to a compartment accommodating one or more aftertreatment bricks 150, specifically in the form of diesel oxidation catalysts (DOC) 152. Although FIG. 2 illustrates individual aftertreatment bricks 150 associated with each of the two inlets 140, different numbers or arrangements of bricks may be present in other embodiments. The DOCs 152 can contain materials such as platinum group metals like platinum or palladium which can catalyze carbon monoxide and hydrocarbons in the exhaust gasses to water and carbon dioxide via the following possible reactions:

CO+½ O₂=CO₂ (1)

[HC]+O₂=CO₂+H₂O (2)

After being directed through the DOCs 152, the aftertreatment system 120 may direct the exhaust gasses onto other devices to further reduce emissions. For example, to reduce nitrogen oxides such as NO and NO₂, sometimes referred to as NO_{X}, the aftertreatment system 120 may include a selective catalytic reduction (SCR) system 160. In the SCR process, a liquid or gaseous reductant agent is introduced to the exhaust system and directed through an SCR catalyst along with the exhaust gasses to convert the NO_{X} to nitrogen (N₂) and water (H₂O). A common reductant agent is urea ((NH₂)₂CO), though other suitable substances such as ammonia (NH₃) can be used in the SCR process. The reaction may occur according to the following general formula:

NH₃+NO_{X}=N₂+H₂O (3)

Referring to FIG. 2, to introduce the reductant agent, a reductant agent injector 162 can be disposed in a central mixing duct 164 that receives the exhaust gasses exiting the DOCs 152. The mixing duct 164 mixes and directs the reductant agent and exhaust gasses toward the reward second wall 128, which disperses the mixture toward the third and fourth sidewalls 130, 132. To initiate the SCR reaction process, a first SCR module 166 and a second SCR module 168 can be oriented toward the third and fourth sidewalls 130, 132, respectively, to receive the redirected mixture. The first and second SCR modules 166, 168 can include a plurality of aftertreatment bricks in the form of SCR catalysts 169 through which the exhaust gasses/reductant agent mixture passes. The SCR catalysts 169 can include materials such as vanadium, molybdenum and tungsten that initiate the SCR reaction. Afterwards, the exhaust gasses can enter a central region 170, surrounding but fluidly separated from the central mixing duct 164, that directs the treated exhaust gasses forward towards the outlets 142 disposed in the first wall 126. In various embodiments, one or more additional exhaust treatment devices can be included in the aftertreatment systems such as diesel particulate filters 172 for removing particulate matter.

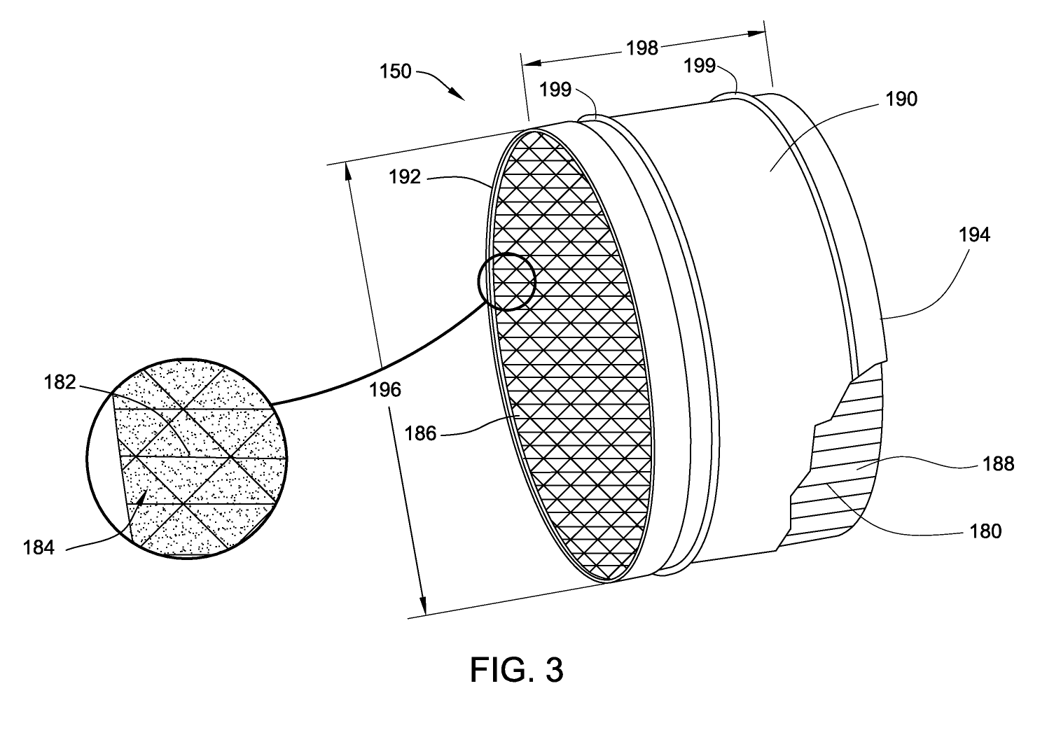

As is apparent from the foregoing description, aftertreatment bricks are available in different types and styles to perform different aftertreatment processes, including as mentioned herein, DOC and SCR processes. Referring to FIG. 3, there is illustrated an embodiment of an aftertreatment brick 150 that may include a catalytic material that causes a catalytic reaction with the exhaust gasses that encounter the brick. To support the catalytic material that performs the chemical reaction, the aftertreatment brick 150 can include an internal substrate matrix 180 made of a triangular lattice, honeycomb lattice, metal mesh substrate, or similar thin-walled support structure 182 onto which the catalytic material or catalytic coating 184 can be disposed. Such flow-through designs for the support structures enable the exhaust gasses and any reductant agent present to pass into and through the aftertreatment brick 150. Any suitable material can be used for the support structure 182 including, for example, ceramics, titanium oxide, or copper zeolite. Catalytic coatings 184 that initiate the catalytic reaction can include various types of metals such as platinum, palladium, vanadium, molybdenum and tungsten. The catalytic coating 184 can be deposited on the support structure 182 by any suitable method including, for example, chemical vapor deposition, adsorption, powder coating, wash coating, spraying, etc. In other embodiments, instead of having separate support structures and catalytic coatings that are often employed together to reduce material costs, the substrate matrix can be made entirely from a catalytic material. In the illustrated embodiment, the substrate matrix 180 has a generally cylindrical shape and extends between a first circular face 186 and a second circular face 188, however, in other embodiments, different shapes can be applied to the substrate matrix, e.g., square, rectangular, etc.

To protect the support structure 182, a tubular mantle 190 can be generally disposed around the substrate matrix 180. The tubular mantle 190 can be made of a thicker or more rigid material than the thin-walled support structure 182, such as aluminum or steel. For example, the mantle may be about 5/16 of an inch thick to provide sufficient structural rigidity to the catalyst. The mantle 190 can be generally cylindrical to correspond to the cylindrical shape of the substrate matrix 180, although in other embodiments, different shapes are contemplated. The tubular mantel 190 can extend between a circular first rim 192 and a corresponding circular second rim 194 that are opened so that exhaust gasses may access the substrate matrix 180. In the illustrated embodiment, the diameter of first and second rim 192, 194 delineates a diameter 196 of the aftertreatment brick while the distance between the first and second rims delineates a length 198 of the aftertreatment brick. By way of example only, the diameter 196 may be approximately 14 inches and the length 198 may be approximately 8 inches.

Disposed around the exterior of the mantle 190 can be one or more circumferentially extending, protruding ribs 199. The ribs 199 may be formed into the tubular skin of the mantle 190 and can protrude, for example, about 0.25 inches beyond the diameter 196. In the illustrated embodiment, two ribs 199 are provided with a first rib oriented toward, but set back from, the first rim 192 and a second rib oriented towards, but set back from, the second rim 194. Furthermore, in some embodiments, the substrate matrix 180 may be coextensive with the length 198 of the mantle such that the first and second faces 186, 188 are flush with the respective first and second rims 192, 194 while, in other embodiments, the first and second faces can be set back from the first and second rims for protection.

Referring back to FIG. 2, to perform the catalytic reaction, the aftertreatment bricks 150 must be disposed in the flow-path of the exhaust gasses inside the aftertreatment system 120 so that the catalytic materials and exhaust gasses can interact. Accordingly, to accommodate the aftertreatment bricks 150, the aftertreatment system may include one or more compartments or chambers, such as a brick compartment 200 that can accommodate the aftertreatment bricks 150 such as the DOCs 152. The brick compartment 200 can be located proximate to the first wall 126 and can be situated between the inlet diffusers 144 and the central mixing duct 164 so that the exhaust gasses traverse the brick compartment. In the illustrated embodiment, the brick compartment 200 is generally rectangular in shape and includes a front wall 202, that may correspond to the first wall 126, and an opposing rear wall 204. The front wall 202 and the rear wall 204 are spaced apart with respect to the system axis line 134 to delineate a void or space that is sized to accommodate a plurality of the aftertreatment bricks 150 in a manner that allows for installation or servicing. To access the brick compartment 200, for example, to install or service the aftertreatment bricks 150, a hatch 206 can be provided in an easily accessible location such as at the top of the aftertreatment system 120 and that may be opened or closed with a removable cover 208 that can be bolted into place.

To receive the incoming exhaust gasses from the inlets 140, one or more entry ports 210 can be disposed through the front wall 202 and to discharge the gasses, one or more exit ports 212 can be disposed through the rear wall 204. In the particular embodiment illustrated, one entry port 210 and one exit port 212 may be provided for each of the two inlets 140 included with the aftertreatment module 120. Further, each associated entry port 210 and exit port 212 can be generally aligned along a port axis 214 extending between the front and rear walls 202, 204 and that is parallel to the system axis line 134. The entry ports 210 and the exit ports 212 may generally correspond in shape and size to the circular aftertreatment bricks 150, e.g., circular. When installed in the compartment, the aftertreatment bricks 150 may be positioned between the entry and exit ports 210, 212 and aligned along the ports axes 214. Accordingly, exhaust gasses traversing the brick compartment 200 will be directed from the entry port 210 through the aftertreatment bricks 150 along the port axis 214 to the exit port 212.

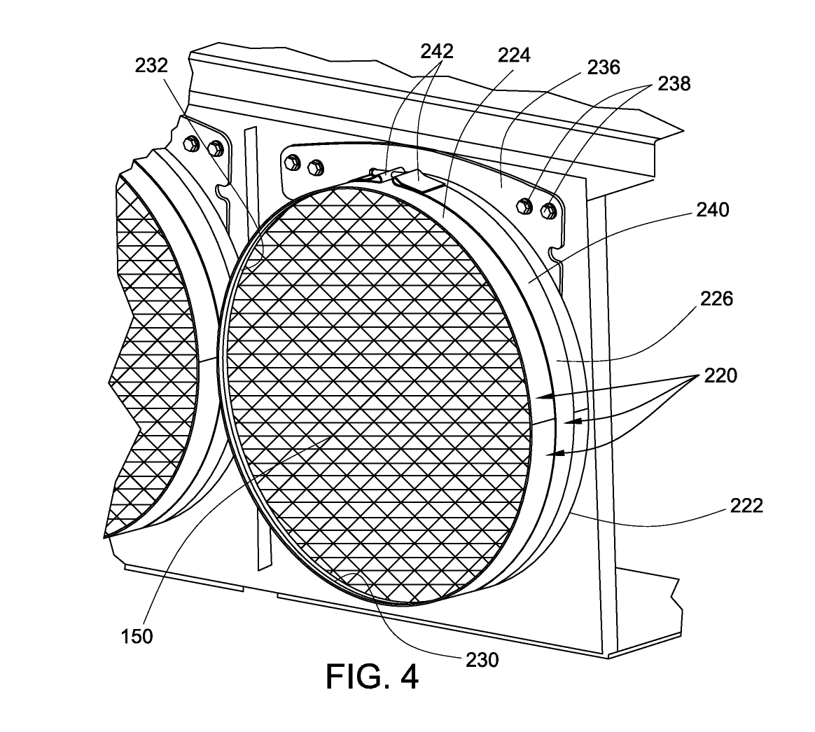

To secure the aftertreatment bricks 150 in their intended location inside the brick compartment 200, a releasable securing assembly may be provided. Referring to FIG. 4, the releasable securing assembly 220 can secure the aftertreatment brick 150 adjacent to either of the ports in a manner that directs the exhausts gasses through the brick. The releasable securing assembly 220 can have a plurality of components that can be assembled together to retain the aftertreatment brick 150 in the desired location with respect to either the front or rear walls 202, 204. Further, the components also can be disassembled to release the aftertreatment brick, for example, during servicing and replacement. In the embodiment illustrated, the components can include a first bracket 222 and a second bracket 224 that are placed around aftertreatment brick and a band clamp 226 that extends around and secures the first and second brackets to the aftertreatment brick. The first bracket 222 may be a lower bracket that supports the lower portion of the aftertreatment brick 150, and the second bracket 224 may be an upper bracket that extends about the upper portion of the aftertreatment brick 150. However, the terms “lower” and “upper” as used herein are relative, provided for orientation purposes only, and are not intended as a limitation on the scope of the claims.

To accommodate the aftertreatment brick 150, the first and second brackets 222, 224 can include surfaces shaped to be complementary with the periphery of the aftertreatment brick. Specifically, the first bracket 222 can include a first surface 230 designed to fit about a portion of the aftertreatment brick and the second bracket 224 can include a second surface 232 designed to fit about another portion of the periphery of the brick. In the illustrated embodiments, where the aftertreatment brick 150 is cylindrical in shape, the first bracket 222 may have a semi-annular shape and the first surface 230 may be curved to correspond to the periphery of the brick. The second bracket 224 can similarly have a semi-annular shape and the second surface 232 can be curved to correspond to the cylindrical shape of the brick. In the specific embodiment illustrated, the first bracket can be formed from a thin rectangular plate of metal that is curved into the semi-annular shape, but in other embodiments could have additional features or framework that positions the lower bracket in the brick compartment with respect to the port. In addition, the second bracket 224 can include a mounting flange 236 extending perpendicularly from the semi-annular shape and, more particularly, extends from a curved edge of the second surface 232 to be flush with the front or rear walls 202, 204 of the brick compartment 200. The mounting flange 236 may include holes or apertures that can accommodate fasteners 238 such as bolts to fix the flange to the wall. In the illustrated embodiment, the first bracket 222 and the second brackets 224 may each extend approximately around half the circumference of the cylindrical aftertreatment brick but, in other embodiments, the degrees of extension may vary. The radius of the curved first and second surface 230, 232 may correspond to the diameter of the aftertreatment brick. In other embodiments, the aftertreatment bricks and brackets may have different complementary shapes.

The band clamp 226 can include an elongated, semi-flexible strap 240 of metal or other suitable material with fasteners or clips 242 disposed at either end that can interlock together to fasten the ends together in a loop. The clips 242 may be configured so that the length and/or diameter of the band clamp 226 are adjustable. Any suitable adjustment mechanism can be used including, for example, ratchets, cooperative screw threads and grooves, threaded rods and nuts, and the like. The band clamp 226 may extend around the exterior of the first and second brackets 222, 224 and can be tightened to secure and possibly compress the brackets around the cylindrical periphery of the aftertreatment brick 150. The band clamp 226 may be positioned so that the clips 242 are oriented along the upper second bracket 224 and towards the hatch for ease of access.

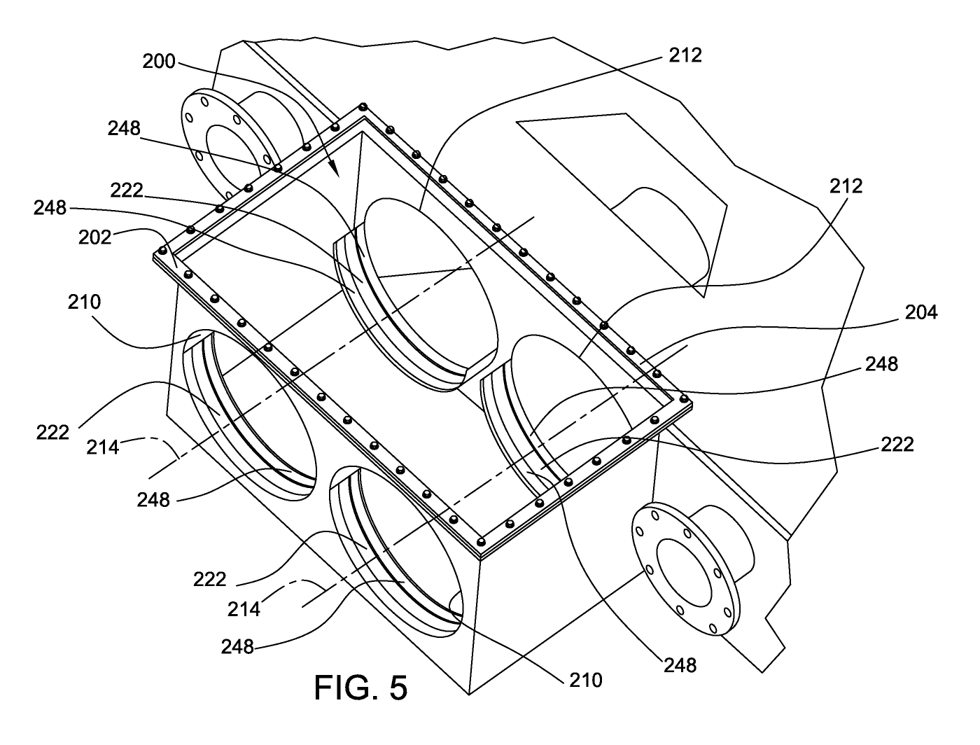

Referring to FIG. 5, to install the aftertreatment brick with the releasable securing assembly 220, the lower first bracket 222 may be fixed or permanently attached inside the brick compartment 200. More specifically, one first bracket 222 may be included proximate each of the lower edges of the entry and exit ports 210, 212, by, for example, welding the first bracket to the front and rear walls 202, 204. The semi-annular shape of the first bracket 222 may be oriented so that the curved first surface 230 faces upwards and is radially oriented toward the port axis 214. The curved first surface 230 and the entry and/or exit ports 210, 212 may dimensionally correspond in size and shape. In a further feature, the curved first surface 230 may include one or more protruding steps 248 that extend circumferentially along the curved surface. The steps 248 can be formed as an integral part of the lower bracket 222 or can be separate pieces of material joined to the curved first surface 230. Because of the steps 248, the curved first surface 230 is generally not uniform or flat.

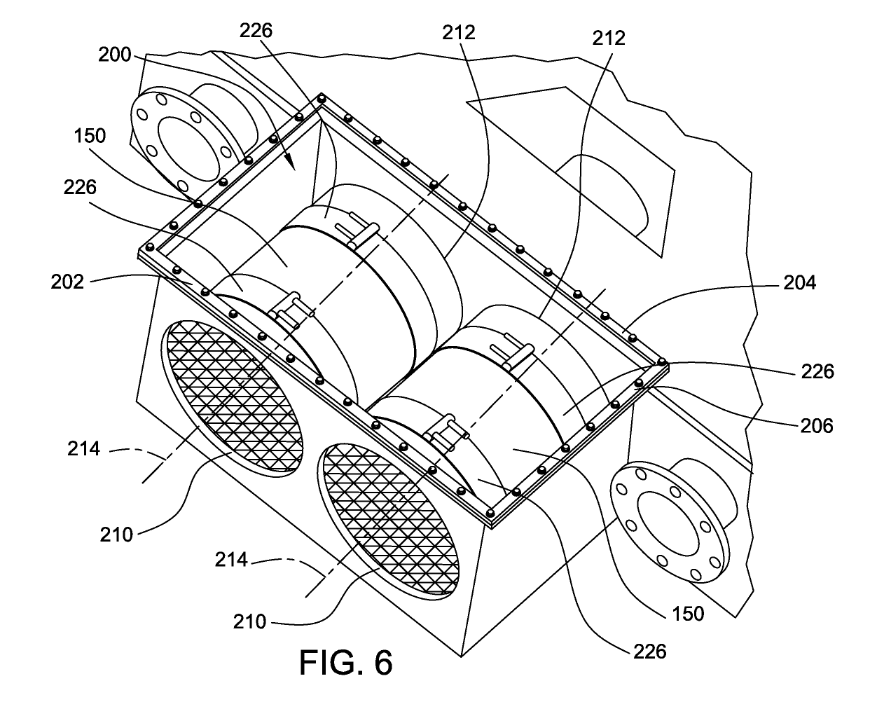

Referring to FIG. 6, the aftertreatment bricks 150 can be inserted through the hatch 206 into the brick compartment 200 and supported on the first brackets. Due to the upward facing curved first surfaces 230 of the lower first brackets 222 shown in FIG. 5, the cylindrical aftertreatment bricks 150 can be generally aligned with the port axes 214 and may traverse the area defined by the ports. In the illustrated embodiment, one aftertreatment brick can be provided per port such that, for the disclosed embodiment, four bricks are included. However, in other embodiments, the aftertreatment bricks 150 may be of a sufficient length to extend between each aligned entry and exit port so that only two bricks are included. The band clamp 226 can be loosely placed around the aftertreatment brick 150 prior to being set inside the compartment. This allows the band clamp 226 to be slide along the port axis 214 away from the front and/or rear walls 202, 204 so that the mantle of the aftertreatment brick 150 contacts the first bracket 222.

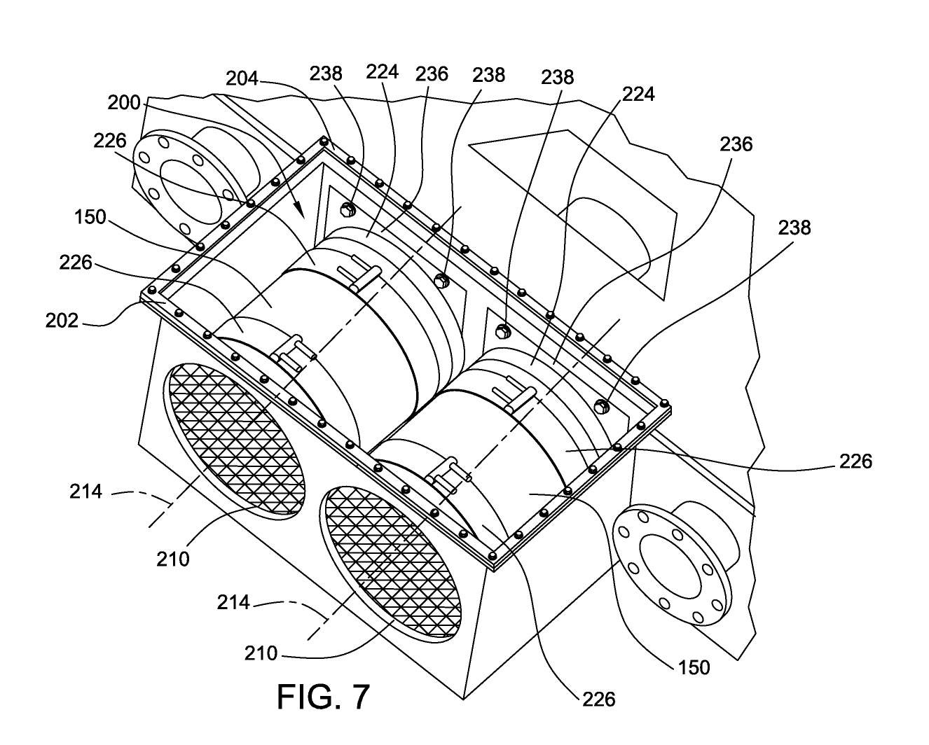

Referring to FIG. 7, the upper second bracket 224 can be inserted into the brick compartment 200 and installed generally proximate an upper edge of each of the entry and exit ports 210, 212. In particular, the curved second surface of the second bracket 224 may extend partially around the aftertreatment brick 150 and is arranged so that the perpendicular mounting flange 236 is flush or adjacent to the front or rear walls 202, 204. The fasteners 238 can be used to releasably secure the second bracket 224 in place. Although FIG. 7 only shows the second brackets 224 being installed with respect to the exit ports 212, it will be appreciated that the second brackets are also installed with respect to the entry ports 210.

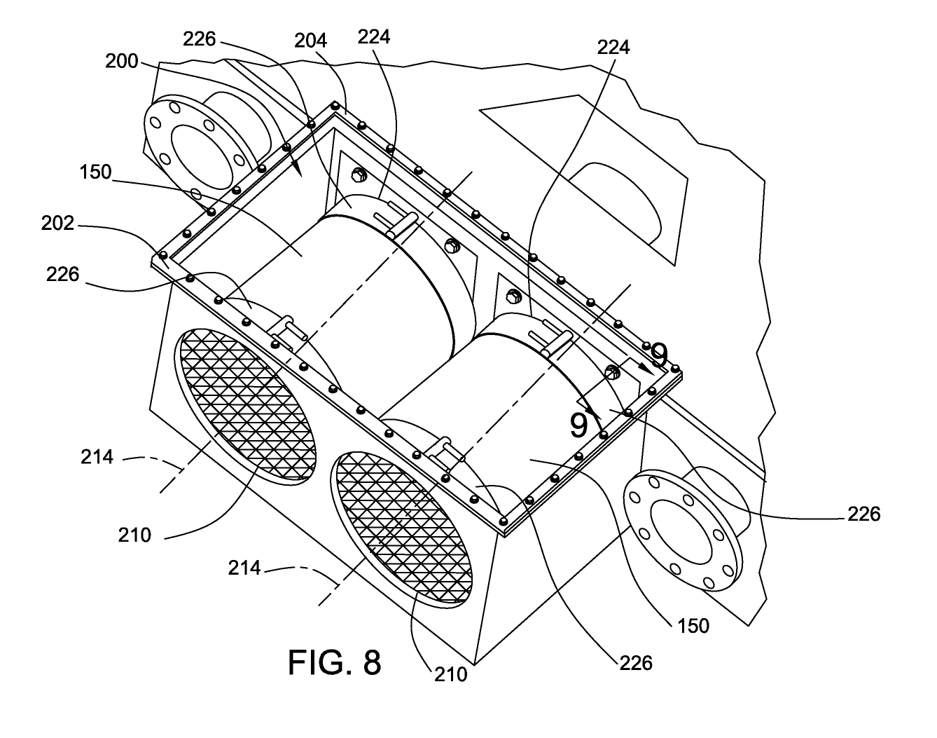

Referring to FIG. 8, the relatively loose band clamps 226 can be slid outward with respect to the port axis 214 towards the respective front or rear walls 202, 204 so that each band clamp moves over and loops around the associated set of first and second brackets 222, 224. Because the first and second brackets have a semi-annular shape similar to the cylindrical surface of the aftertreatment brick, the band clamps 226 can be readily slid over the brackets without obstruction. The band clamps 226 can be tightened to reduce their diameters so that the first and second brackets 222, 224 radially compress about the aftertreatment brick 150 and secure the brick adjacent the respective port. Because the first brackets 222 that support the aftertreatment bricks 150 are radially aligned with the port axis 214, the aftertreatment brick will likewise be centered with the port axis. Hence, the aftertreatment bricks are secured in place against vibrations that may be produced by the power system that propagate through the aftertreatment system and against pressure fluctuations that may be present in the incoming exhaust gasses.

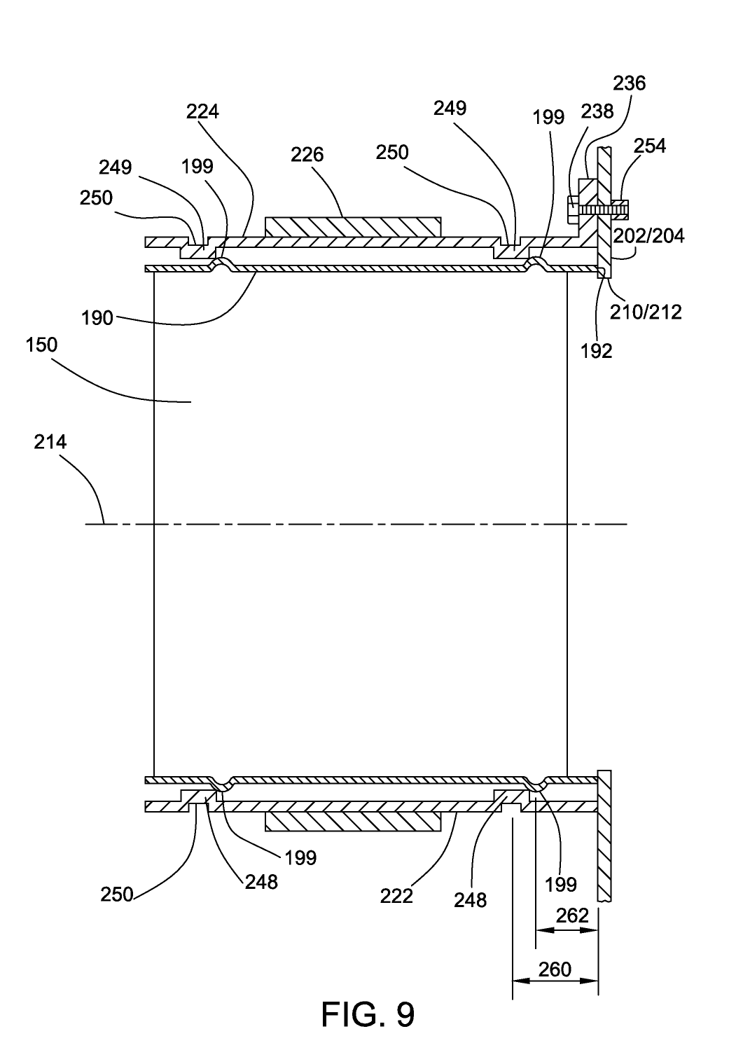

Referring to FIG. 9, in a further feature, the protruding ribs 199 extending about the circumference of the aftertreatment brick 150 can interact with the steps 248 disposed on the first bracket 222 to locate and secure the aftertreatment brick with respect to the respective port. When the aftertreatment brick 150 is set on the first bracket 222, the two ribs 199 can be placed or oriented toward the same respective side of the respective two steps 248, e.g., to the right of the steps in the illustrated embodiment. Further, a second set of second steps 249 can protrude from the inner curved surface of the second bracket 224 and, when the second bracket 224 is installed over the aftertreatment brick 150, can abut against the same side of the ribs 199 extending around the upper part of the aftertreatment brick. To initiate interaction between the steps 248, 249 and the ribs 199, the band clamp 226 is placed around and tightened about the first and second brackets 222, 224. Tightening of the band clamp 226 can inwardly compress the brackets 222, 224 that can result in sliding engagement between the steps 248, 249 and the ribs 199. As the steps 248, 249 and ribs 199 slide into contact, the steps can urge the aftertreatment brick 150 along the direction of the axis line 214 toward the entry or exit port 210, 212 disposed in the wall of the compartment. To facilitate compression of the first and second brackets 222, 224, small grooves 250 may be disposed into the first and second brackets proximate to the location of the steps 248, 249 to provide a degree of relative flexibility.

The locations and dimensions of the steps 248 on the brackets and the ribs 199 on the aftertreatment brick 150 can be arranged so that the first rim 192 of the mantle 190 of the aftertreatment brick is moved into abutting contact with the wall 210, 212 of the brick compartment. To achieve this, a first axial distance indicated by arrow 260 between the step 248 and the inside surface of the compartment wall 210, 212, when the first bracket 222 is attached thereto and a second axial distance indicated by arrow 262 between the rib 199 and the first rim 192 of the aftertreatment brick 150 can be correlated. Specifically, the second axial distance 262 is slightly smaller than the first axial distance 260 so that the steps 248 are positioned at the side of the rib 199 opposite the orientation of the compartment wall 210, 212, as described above, and urge the aftertreatment brick 150 against the compartment wall. Contact between the first rim 192 of the mantle 190 and the compartment walls 210, 212 may form a seal between the aftertreatment brick and the entry or exit ports 210, 212 preventing leakage of the exhaust gasses and assist in directing exhaust gasses through the bricks.

At this point, to releasably secure the second bracket 224 to the inside of the brick compartment in a manner that completes the assembly of the aftertreatment brick and first and second brackets inside the brick compartment, the fasteners 238 can be inserted through holes in the mounting flange 236 of the second bracket and threaded to the compartment wall. In an embodiment, to receive the fasteners 238, a threaded nut or boss 252 may be disposed on the opposite side of the compartment wall 210, 212. The aftertreatment brick 150 is thereby releasably secured in a substantially leak free manner proximate the respective entry or exit ports 210, 212

### INDUSTRIAL APPLICABILITY

The present disclosure is applicable to the installation and servicing of aftertreatment bricks in an aftertreatment system for treating exhaust gasses, which may be beneficial if the bricks become damaged or depleted. Referring to FIGS. 2 and 4, to access the aftertreatment bricks accommodated in an aftertreatment system 120 such as a clean emissions module, an operator may remove the cover 208 to open the hatch 206 to a brick compartment located in the exhaust gas flow path. The hatch 206 can be located in an accessible area such as the top of the aftertreatment system 120. The operator can remove a presently installed aftertreatment brick 150 by first removing upper second bracket 224 securing the aftertreatment brick in place. This can be accomplished by loosening the adjustable band clamp 226 and axially sliding it along the aftertreatment brick off the first and second brackets 222, 224. The fasteners 238 that fasten the perpendicular mounting flange 236 flush to the wall can be loosened and removed with an appropriate tool. The dismounted upper bracket 224 can be removed though the opened hatch 206. Because the upper second bracket 224 and its fasteners 238 are located proximate the hatch 206, they are readily accessible to an operator performing the installation. Additionally, because the band clamp 226 is arranged so that the clips 242 are oriented toward the hatch 206, they can be easily accessed as well.

Because the aftertreatment brick 150 is no longer vertically constrained by the second bracket 224 and the band clamp 226 has been axially displaced with respect to the first bracket 222, the aftertreatment brick can also be removed through the open hatch 206. The same aftertreatment brick can be serviced and reinstalled, or a new aftertreatment brick can be installed, by reversing the foregoing process. The same first bracket, second bracket and band clamps can be reused. If necessary, the operator can sever the low cost fasteners 238 if they have become corroded by galling or the like during the removal process and replace them with the new fasteners. Referring to FIG. 9, in the embodiments having steps protruding from the first and second brackets 222, 224, the steps can engage with the ribs on the mantle of the aftertreatment bricks to urge the bricks against the ports in the brick compartment 212, 212.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method of releasably securing an aftertreatment brick in an aftertreatment system comprising:
installing a first bracket in a brick compartment disposed in an exhaust flow path, the first bracket having a first surface complementary to a periphery of the aftertreatment brick;
placing the aftertreatment brick on the first bracket so that the first surface is adjacent a portion of the periphery;
installing a second bracket in the brick compartment, the second bracket including a second surface complementary to the periphery of the aftertreatment brick, the second bracket installed so that the second surface is adjacent another portion of the periphery; and
securing a band clamp about the first and second brackets to secure the first and second brackets to the aftertreatment brick.

2. The method of claim 1, wherein the periphery of the aftertreatment brick is cylindrical, and the first surface and second surface are curved.

3. The method of claim 2, wherein installation of the first bracket involves welding the first bracket to the brick compartment.

4. The method of claim 3, wherein installation of the second bracket involves fastening the second bracket to the brick compartment.

5. The method of claim 4, wherein the second bracket includes a mounting flange adapted to be adjacent to the brick compartment, the mounting flange including a plurality of apertures for receiving fasteners.

6. The method of claim 5, wherein the first bracket and the second bracket are semi-annular in shape.

7. The method of claim 6, wherein the band clamp is adjustable.

8. The method of claim 7, wherein securing the band clamp about the first bracket and the second bracket involves:
sliding the band clamp over the first bracket and second bracket; and
tightening the band clamp to compress the first bracket and the second bracket about the aftertreatment brick.

9. The method of claim 1, wherein at least one of the first surface and second surface includes a step, and the periphery of the aftertreatment brick includes a rib, the step and rib placed in adjacent, abutting contact to urge the aftertreatment brick toward a wall of the brick compartment.

10. The method of claim 9, wherein the aftertreatment brick is adjacent a port.

11. A releasable securing assembly for securing an aftertreatment brick inside an aftertreatment system, the releasable securing assembly comprising:
a first bracket having a first surface complementary to a periphery of the aftertreatment brick, the first bracket adapted to be permanently installed in a brick compartment of the aftertreatment system;
a second bracket having a second surface complementary to the periphery of the aftertreatment brick, the second bracket adapted to be removably installed in the brick compartment; and
a band clamp adapted to be secured about the first bracket and the second bracket to compress the first bracket and the second bracket about the aftertreatment brick.

12. The releasable securing assembly of claim 11, wherein the periphery of the aftertreatment brick is cylindrical and the first surface and the second surface are curved.

13. The releasable securing assembly of claim 12, wherein the first bracket and the second bracket are semi-annular in shape.

14. The releasable securing assembly of claim 13, wherein the band clamp is adjustable in size.

15. The releasable securing assembly of claim 14, wherein the second bracket includes a mounting flange adapted to be fastened to the brick compartment

16. The releasable securing assembly of claim 11, wherein the periphery of the aftertreatment brick includes a rib, and at least one of the first surface and the second surface include a step, the rib and step adapted to abut after assembly to urge the aftertreatment brick against a wall of the brick compartment.

17. A method of servicing an aftertreatment brick in an aftertreatment system, the method including:
accessing a brick compartment in the aftertreatment system through an access hatch;
sliding a band clamp off a first bracket and a second bracket securing an aftertreatment brick in the brick compartment;
uninstalling a second bracket proximate the hatch and removing the second bracket from the brick compartment; and
lifting the aftertreatment brick from the first bracket and removing aftertreatment brick from the brick compartment.

18. The method of claim 17, further comprising:
inserting a new aftertreatment brick into the brick compartment and supporting the new aftertreatment brick on the first bracket;
installing the second bracket about a portion of a periphery of the new aftertreatment brick; and
sliding the band clamp about the first bracket and second bracket to securing the new aftertreatment brick in the brick compartment.

19. The method of claim 18, wherein the first bracket includes a first surface, and the second bracket includes a second surface, the first surface and the second surface complementary to the periphery of the aftertreatment brick.

20. The method of claim 19, wherein the periphery of the aftertreatment brick is cylindrical, and the first surface and the second surface are curved.
